(19) United States
(12) Patent Application Publication
(10) Pub. No.: US 2008/0163225 A1
(43) Pub. Date: Jul. 3, 2008

(54) METHOD AND/OR SYSTEM FOR TASK SCHEDULING

(76) Inventors: Thomas F. Fragala, Santa Barbara, CA (US); Eric Valinsky, Santa Barbara, CA (US)

Correspondence Address: BERKELEY LAW & TECHNOLOGY GROUP, LLP, 17933 NW Evergreen Parkway, Suite 250, BEAVERTON, OR, 97006, US

(21) Appl. No.: 11/618,525

(22) Filed: Dec. 29, 2006

(51) Int. Cl. G06F 9/46

(52) U.S. Cl. 718/102

(57) ABSTRACT

Embodiments of a method and/or system for task scheduling is disclosed.

### BACKGROUND

This disclosure relates to task scheduling, such as, a method and/or system for task scheduling.

Some problems may be addressed through self-service by following a procedure or set of procedures. However, some self-service procedures may be time intensive and/or have other issues associated with their use, such as involving a high level of knowledge to be effectively utilized. Therefore, an approach to reduce the time to apply such procedures or address such other issues may be desirable.

### BRIEF DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference to the following detailed description if read with the accompanying drawings in which:

FIG. 1 is a schematic diagram illustrating an embodiment of a computing platform.

FIG. 2 is a flowchart illustrating an embodiment of a method for task scheduling.

FIG. 3 is a flowchart illustrating an aspect of the embodiment of FIG. 2 in more detail.

FIG. 4 is a flowchart illustrating another aspect of an embodiment of a method for task scheduling.

FIG. 5 is a flowchart illustrating a portion of another embodiment of a method for task scheduling.

FIG. 6 is a flowchart illustrating an implementation of yet another embodiment of a method for task scheduling.

FIG. 7 is a flowchart illustrating still another embodiment implementing a method of task scheduling.

### DETAILED DESCRIPTION

In the following detailed description, numerous specific details are set forth in order to provide a thorough understanding of claimed subject matter. However, it will be understood by those skilled in the art that claimed subject matter may be practiced without these specific details. In other instances, well-known methods, procedures, and components have not been described in detail so as not to obscure claimed subject matter.

Unless specifically stated otherwise, as apparent from the following discussion, it is appreciated that throughout this specification a computing platform comprises a device, such as a computer or a similar electronic computing device, capable of manipulating and/or transforming data represented as physical, electronic and/or magnetic quantities and/or other physical quantities within the computing platform's processors, memories, registers, and/or other information storage, transmission, reception and/or display devices. Accordingly, a computing platform refers to a system or a device that includes the ability to process and/or store data in the form of signals. Thus, a computing platform, in this context, may comprise hardware, software, firmware and/or any combination thereof. Where it is described that a user may instruct a computing platform to perform a certain action it is understood that instruct may mean to direct or otherwise result in performance of the action by the computing platform as a result of a selection or action by a user. A user may, for example, instruct or direct a computing platform, without limitation, for example, by pushing a key, clicking a mouse, maneuvering a pointer, touching a touch screen, providing voice commands, any combination of the foregoing, and more. Furthermore, an end-user is one example of a type of user.

Flowcharts, also referred to conventionally as flow diagrams, are used herein to illustrate aspects of various embodiments, but are not intended to be exhaustive or limiting in their depiction. To this end, many well-known techniques, design choices and the like are described in detail so as that to not obscure the subject matter that is intended to be conveyed.

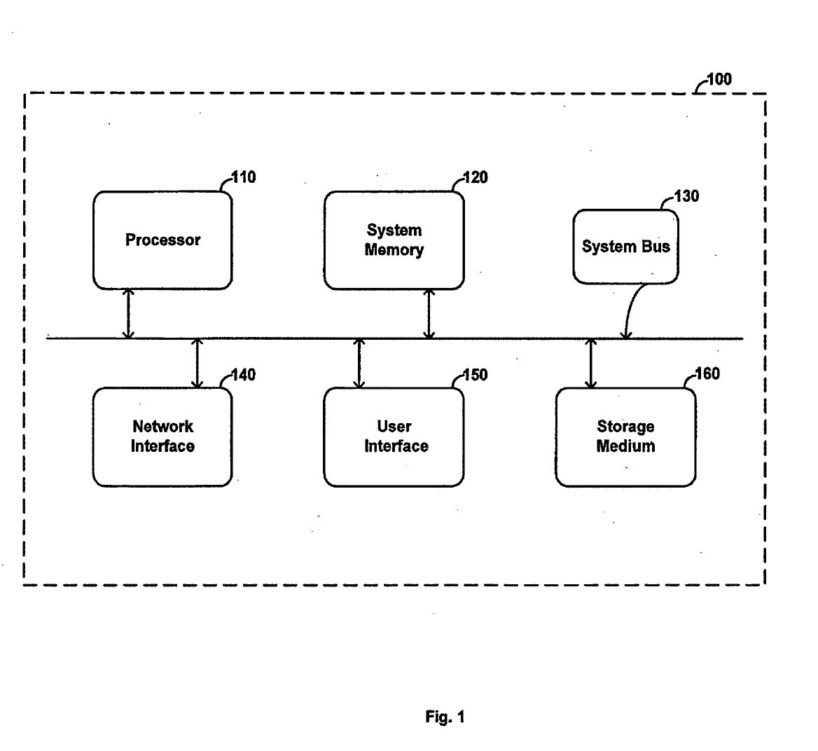

FIG. 1 is a schematic diagram of an embodiment of a computing platform. In one embodiment, such a computing platform may be employed or adapted to diagnose and then potentially address problems having specific common characteristics or in which a similar template or similar approach to addressing may be applied. In general, it may be desirable to have the ability to address problems having a similar construct or similar features without, for example, having the user specify the common construct or features, other than by being prompted or otherwise queried, for example, for information, designed to assess whether the problem at hand fits within such a common construct. For example, without limitation, it may be desirable to track or otherwise manage tasks that may be redundant and/or repetitive to accomplish more intelligent execution. Likewise it may be desirable that such a method and/or system be sufficiently flexible that a range or variety of such problems may be addressed, rather than employing a different method or system for each different variation. Potential advantages, without limitation, may include reducing development time and quicker deployment of such systems.

Following is a list comprising examples, though not the only examples possible, of applications suitable for implementing alternative embodiments in accordance with claimed subject matter. Throughout this specification, the term system may, depending at least in part on the particular context, be understood to include any method, process, apparatus, and/or other patentable subject matter that implements the subject matter disclosed herein. In particular, but without limitation, these may comprise examples of problems or situations in which redundant and/or repetitive tasks have the potential to be more intelligently managed:
Filing or Preparation of various sorts of documents, including, for example: Schooling or College Applications, Mortgage Applications, Taxation Filings, Law Enforcement Reports, Audit Reports, Tribunal or Agency Filings, and the like;
Product and/or Software Development; and/or
Disaster Preparedness.

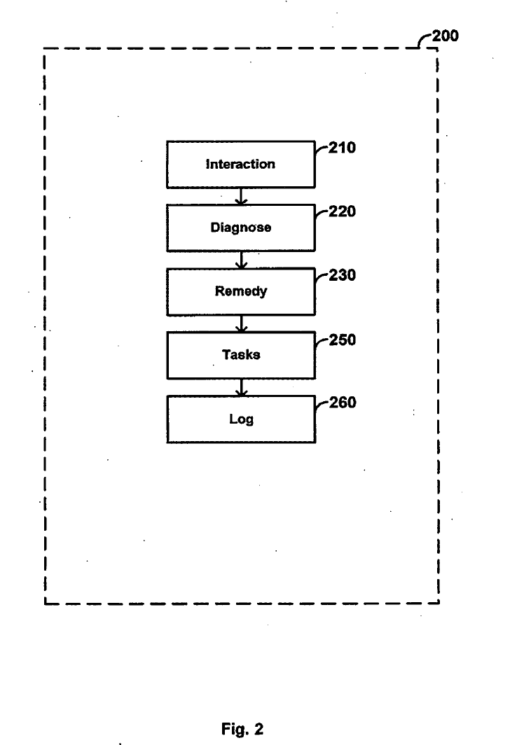

FIG. 2 is a flowchart illustrating an embodiment of a method of task scheduling. The operations depicted in FIG. 2 may be implemented, by way of non-limiting example, via a system, such as 200, as shown by the embodiment illustrated in FIG. 1. In one such embodiment, such operations may be implemented through the execution of software, although claimed subject matter is not limited in scope in this respect. In one such embodiment, software to be executed may be stored on a storage medium, such as 160, for example, illustrated in FIG. 1. Storage medium 160 may, for example, comprise a magnetic, optical, electronic or other storage device, although, again, claimed subject matter is not limited in scope in this respect.

In one embodiment, such as one utilizing computing platform 100, a processor, such as 110, may read data from storage medium 160 via a system bus 130 and write such data to system memory, such as 120. One example of such data may comprise a software module to implement an embodiment of a method or process as described in more detail hereinafter. In this particular embodiment, a user may connect locally through a user interface, such as 150, or remotely through a network interface, such as 140, although, again, claimed subject matter is not limited in scope in this respect. During an interaction 210, such as a user may be prompted to provide information, such as, for example, via questions intended to identify whether the problem at hand falls within a range of common characteristics or features. For this particular embodiment, through an interaction, such as 210, system 200 may acquire sufficient data to perform this identification or diagnosis, such as 220. This may comprise an iterative process, as described in more detail hereinafter. Of course, claimed subject matter is not limited in scope to acquiring information or data in the manner previously described. For example, in an alternate embodiment, a computing platform or other system may obtain or acquire information from external sources, including, without limitation, for example, the World Wide Web. Therefore, simply for the sake of clarity, without intending to be limiting in any way, while some embodiments within the scope of claimed subject matter may contemplate direct interaction with a user, likewise, other embodiments within the scope of claimed subject matter may not contemplate or involve direct interaction with a user.

An accurate identification or diagnosis by system 200 may likewise result in a proposed course of action intended to address the problem at least in part, referred to here as a remedy, such as 230. As will become more clear hereinafter, a remedy, such as 230, may be the result of information provided or specified by a team of “experts” familiar with problems similar to the diagnosis obtained by application of system 200. Likewise, a given diagnosis may have more than one remedy.

As explained in more detail later, a particular remedy, such as 230 may result in a selected series of tasks or task items to be loaded either for current scheduling or for later scheduling. Scheduling may include, for example in this embodiment, but is not limited to, calendaring tasks and/or other events, also described in more detail below. Likewise, scheduling may be accomplished without reference to a particular calendar or other time/date keeping mechanism. System 200 may, as a result of a particular remedy, for example, assign tasks or task items 250 to a user and log user answers and results 260. Eventually, a user's problem may be sufficiently addressed so that no further tasks or task items are assigned and no further logging or results takes place.

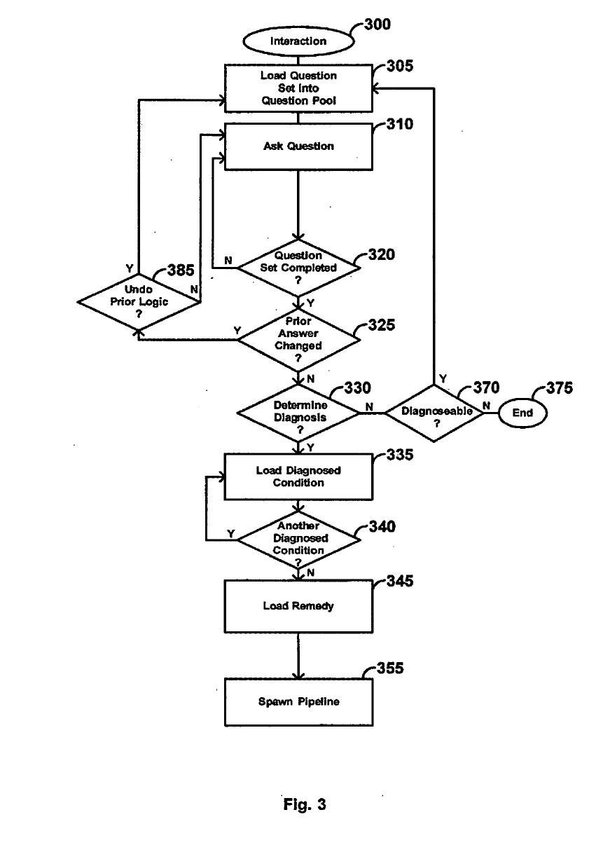

FIG. 3 is a flow chart illustrating one embodiment of an interaction process. Of course, claimed subject matter is not limited in scope to this particular embodiment. However, in this embodiment, an interaction, such as 300, for example, may begin with a question set being loaded into a question pool 305. A question set may comprise a set of interrelated questions potentially pertinent to problems having a similar set of features or characteristics. A question set in one embodiment may comprise a screen of questions presented a user, such as at 310, for example, although, of course, claimed subject matter is not limited in scope in this respect. A user may be prompted to provide information, such as answers and/or other responses, for example, for evaluation through a variety of mechanisms.

Questions may be loaded into a pool from which they may be drawn sequentially or by priority, for example. Responses may result in adaptive processing by the system. In this context, the term adaptive processing refers to real-time, on-the-fly changes, or a periodic changes in data processing based at least in part on information recently collected. More specifically, different responses may alter the successor or subsequent questions provided. Responses may be utilized to clarify a set of task items, potential inter-relationships, and to determine a schedule of the task items so as to address the problem at least in part.

The order in which the system may present questions may vary depending at least in part upon a logical construct applied by the system. In this context, the term logical construct includes an idea and/or framework inferred or derived from specific instances such as where a higher level understanding is formed from a set of lower level elements. It includes, but is not limited to, a derived framework or established template. Likewise, a logical construct may determine if the question set has resulted in acquiring sufficient information, as illustrated by 320, to at least in part attempt diagnosis. If sufficient information has not been elicited, the system may prompt the user for further information, such as via further questions. Again, prompting a user to provide information may take any one of a number of potential forms and claimed subject matter is not limited in scope in this respect. Examples, without limitation, of forms in which information may be provided includes: free-form text, answers to questions, and/or menu selections. Likewise, as information is provided, the system may parse the information to determine whether or not previously provided information may have changed, such as illustrated by 325. If so, the system may apply the particular logical construct to determine if adaptive processing should result. Adaptive processing, for example, may include reformulating or re-collecting information that have previously been collected, through additional prompting. In this context, this may be referred to as “undoing” the information that had previously been collected to identify the problem.

To accomplish this adaptive processing, another question set may be loaded into the question pool. Similarly, the system may reload a previous question set into the question pool. Likewise, should information be changed to what had previously been submitted, the system may likewise “redo” a previous adaptation. If the system has acquired sufficient information, the system may attempt to determine a diagnosis, such as illustrated by 330.

If the system is able to determine a diagnosis 330, the system may load a diagnosed condition 335. Likewise, the system, as it collects information, may evaluate if the problem is within the logical construct of problems the system is intended to evaluate and, hence, is diagnosable or if the problem is outside the logical construct and, hence, not diagnosable. If the system determines that the problem is potentially diagnosable, as illustrated by 370, it may load additional question sets into the question pool 305. Alternatively, should the system determine that for this embodiment of the system the problem is not diagnosable, such as at 370, system operation may reach an end 375 or otherwise no longer process information to perform a problem identification.

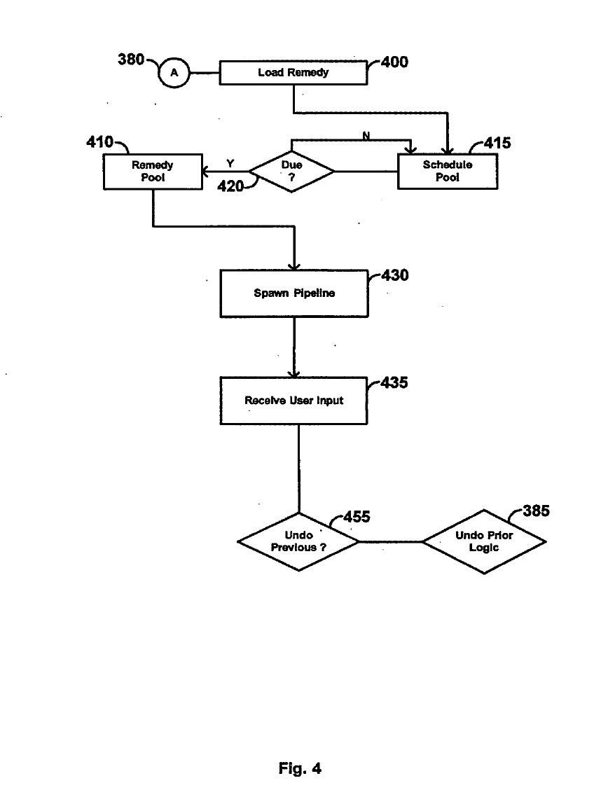

In an embodiment, the system may continue to evaluate whether or not there is another diagnosed condition 340, in addition to previously identified diagnosed conditions or problems. Likewise, the system may be adapted to provide a suggested fix or remedy. To this end the system may load a set of remedies 345 into a remedy pool. Once a remedy is loaded, the system may spawn a pipeline 355, as described in more detail and as illustrated in FIG. 4.

FIG. 4 is a flowchart illustrating another aspect of an embodiment of a method of task scheduling. Throughout this specification, although the terms task(s) and task item(s) are used interchangeably without loss of generality, the particular meaning intended will depend at least in part on the particular context. In this context, a pipeline represents a flexible series of tasks to implement a particular remedy. A pipeline for a particular remedy determines the tasks to be loaded after a current task is performed. In one embodiment, a pipeline may sequentially control the order and interrelationship of tasks or task items to be performed. Likewise, in some embodiments, a pipeline may branch, although claimed subject matter is not limited in scope in this respect. Likewise, in an embodiment, a pipeline may be multithreaded in that the results of one task or task item may result in more than one task or task item being loaded. Likewise, depending at least in part upon the particular embodiment, pipelining may comprise multithreading related tasks or task items.

As previously suggested, a pipeline, in effect, implements a particular remedy by specifying a procedure of related tasks or task items to be performed. A system may perform a spawn pipeline 400 operation so as to initiate a remedy procedure. In one embodiment, a system may determine the timing of the executing of a remedy, whether it is to be performed once or repeatedly for a determined or undetermined number of instances. If a remedy is due for immediate performance, for example, the system may proceed to load it into the remedy pool 410. Likewise if the remedy is loaded into the pool, the system may spawn a pipeline 430 that may result in the tasks or task items to be presented, although, again, claimed subject matter is not limited in scope to this particular embodiment. If a remedy is due for repeated or recurring performance, the system may proceed to load it into the schedule pool, such as 415. Likewise, for this embodiment, although claimed subject matter is not limited in scope in this respect, one or more pipelines may be spawned without all possible remedies first being loaded.

An example may demonstrate this flexibility of the system with respect to timing of tasks or task items of a remedy. For example, suppose a logical construct of a system relates to preventative measures taken by examining credit reports on a regular basis. If so, the system may, instead of performing the remedy, load it into a schedule pool 415. To implement this, logic may periodically or a periodically be executed by the system to determine if a remedy in a schedule pool 415 is due, such as at 420, to be executed or performed. Once a remedy is due to be executed or performed, such as illustrated by 420, a copy of the remedy may be created in the remedy pool.

A remedy, in this context, therefore, refers to a procedure or a series of related tasks or task items, as may be presented by a pipeline, such as for this particular embodiment. Typically, a particular remedy includes multiple tasks or task items, although claimed subject matter is not limited in scope in this respect. Likewise, for some embodiments, tasks may be performed sequentially, whereas for other embodiments, tasks may be performed concurrently. Tasks may, likewise, be interdependent. In this context, the term interdependent, if used with reference to tasks or task items, refers to the possibility that one or more downstream tasks or task items may not be performed unless and/or until one or more tasks or task items predicate to the one or more downstream tasks or task items are performed. In one embodiment, for example, interdependent tasks may, for example, initiate loading of further related questions, although this is merely an example and is not intended to be limiting.

Task or task item ordering may be determined or set by various mechanisms. For example, at the time of development of a system, ordering may be determined in one embodiment. However, in another embodiment, tasks or tasks may be ordered by a user, such as an end user. In this context, task ordering refers to a temporal organization and/or grouping. This may include, without limitation, sequential tasks. Likewise, tasks may be prioritized as part of an ordering.

Likewise, due to the potential for interdependence, changes to one or more tasks or task items may produce changes to one or more other tasks or task items. Thus, an embodiment may contemplate this by cascading one or more changes throughout a set of related tasks or task items. For example, if a scheduled time for a task item is changed, the scheduling of related task items may change. In this manner, such changes may be cascaded throughout a schedule.

The scheduling of tasks may be undone or redone in one embodiment. Likewise, for some embodiments, a task undone may likewise be redone. More specifically, a system may reschedule one or more tasks that have been previously undone. Task(s) in turn may be broken down into task items. A task in this context generally refers to a discrete, self-contained action that may be performed or executed. A task item is one of the components in this action. Examples, without limitation, may include: writing a letter, addressing a letter, certifying a letter, and/or mailing a letter. The task items taken together may result in the performance of a task.

In some embodiments, information may be shared among tasks. Returning to our identity theft example, credit card company contact information, once entered, may be made available to any task without repetitive entry. In an embodiment, tasks or task items may comprise self-service tasks a user may perform. A user may, for example, provide or obtain information or data and/or perform a task or task item such as placing a phone call.

A task pool includes task items associated with given remedies, including their temporal sequencing and temporal relationships. A selected task item, for example, may be scheduled for performance or execution. The system may prompt the user for information regarding status of the execution of this task item. If part of a task was to write and mail a particular letter, for example, the system may receive user information regarding such task items. If this information, for example, indicates the task is sufficiently complete, the system may determine a successor task item to undertake, for example. Likewise, if the results of received user input 435 suggest that the problem or issue a user may be dealing with is more nuanced or complicated than originally diagnosed, or now appears to have added dimensions, the system may resume the interaction process by prompting the user to provide additional information in response to additional questions by loading a question set into a question pool 305. Similarly, information may reveal that it may be desirable to undo previous 455 operations via undo prior logic 385, for example, although claimed subject matter is not limited in scope in this respect.

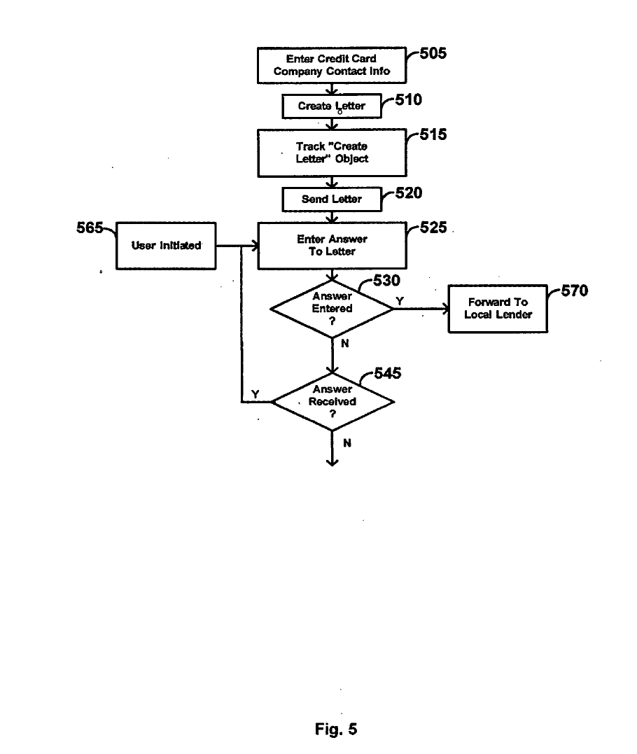

FIG. 5 is a flowchart illustrating a portion of another embodiment of a method for task scheduling. Returning to the previously described application example, a user may be prompted to draft and send a letter to a credit card company. In one embodiment, for example, a software module may be implemented related to executing this operation. A user may be prompted to enter credit card company contact information 505, for example. Likewise, this information may be made available to other task items once entered, as previously described.

Upon a user electing to create a letter 510, the system may commence tracking the “create letter” object 515, for example. A user may be prompted to send the letter 520 and following this, the system may log this event as having occurred. Similarly the system may track that a response to the letter is expected. In one embodiment, for example, the system may periodically verify whether or not an answer has been entered 530. A date may be associated with the letter, such as a log date, and then some amount of time added for scheduling purposes. Of course, this may be implemented any one of a number of different ways and claimed subject matter is not limited in scope to any particular approach. For example, a fixed time period may be incremented, although this is merely one example. Instead, successively changing periods may be employed or a set of dates may be scheduled. Again, claimed subject matter is not limited in scope to any particular approach or mechanism. Likewise, scheduling values may be derived from any one of many sources. Similarly, a number of repetitions to repeat may be introduced.

In one embodiment, a system scheduling operation may be invoked. If a scheduled date has occurred, the system may send a query to a user inquiring if an answer has been received 545 from the credit card company. Likewise, should a user respond that an answer has not been received, the system may reschedule the next time to query a user about this event. Such a query, or any other communication from the system for that matter, may be sent via any one of a variety of different mediums and claimed subject matter is not limited in scope in this respect. As one example, an email may be sent to a user. Likewise, in one embodiment, a user may not need to wait for the system to request input. Instead, a user initiated 565 data entry may enter the answer to the letter 525 at a time of a user's choosing. After an answer is entered 530, subsequent tasks may follow, such as, for example forwarding the answer to a local lender 570.

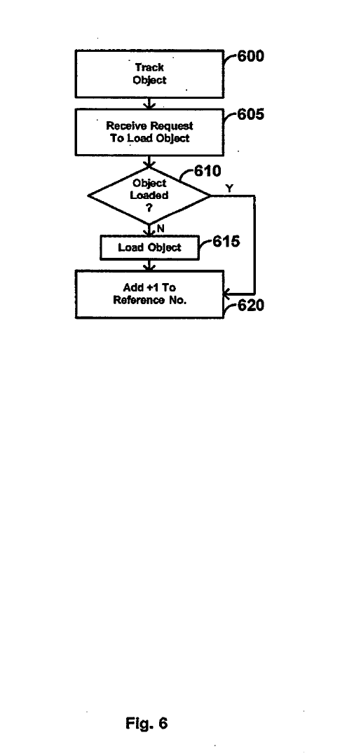

FIG. 6 is a flowchart illustrating an embodiment implementing a method of task scheduling. In this example, an object, such as, for example, a “create letter” object may be tracked, as illustrated, for example, by 600, although this is merely provided to illustrate a possible implementation. Claimed subject matter is not limited to a “create letter” object or to this particular implementation. A user may invoke a task leading to the system receiving a request to load, for example, a “create letter” object. Having received the request to load the object, such as illustrated by 605, the system may load the object, illustrated by 615, and associated a reference number, here one, with the object for example, to begin tracking loading requests or calls of the object. If instead, however, the object was already loaded, as illustrated by 610, then the system, rather than loading a second copy of the “create letter” object would, instead, add one to a reference number, as illustrated at 620. Therefore, in this example, if the system had received two requests to load the “create letter” object, the reference number would be incremented to two.

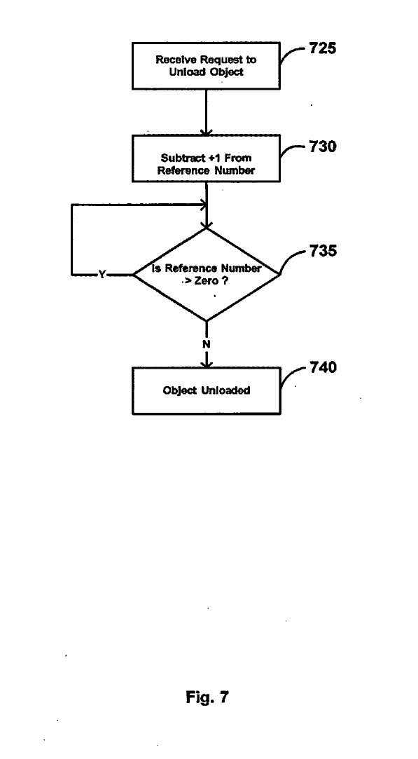

FIG. 7 is a flowchart illustrating still another embodiment implementing a method of task scheduling. The system may receive a request to unload an object, such as by way of illustration, a “create letter” object, such as illustrated by 725; however, of course, claimed subject matter is not limited in scope in this respect.. If one letter is completed, in one embodiment, for example the system may execute the logic from the second request without waiting for a response from the user.

If one of the requests for the object is removed, the system may execute a call to subtract one from the reference number, such as at 730, for example, so that the reference number would decrement to one. Thus, for this particular embodiment, decrementing takes place after unloading, rather than after completing the task, although claimed subject matter is not limited in scope in this respect. The system may at some other time check to see if the reference number comprises a value greater than zero, such as at 735, for example, indicating that the object is still in use. As long as the reference number comprises a number more than zero, the object remains active. However, again, this is merely one particular embodiment and many other embodiments other than the approach just described are possible and included within the scope of claimed subject matter.

However, after the reference number is decremented to zero, the object is unloaded, it is not deleted. Instead, the object is inactivated as a result of the unloading, such as illustrated by 740. By unloading the object, it may be reactivated in performance of a redo operation. Also, a previously reactivated object may be inactivated in the performance of an undo operation. A similar approach may be applied to tasks, log events and other related system actions and/or attributes. For example, if an event is logged, such as, for example, by performance of a task, even if unloaded, the record remains intact. Providing, without limitation, a practical illustration, if performance of a task resulting in the placing of a phone call and the phone call was logged, unloading does not remove or delete the log. Similarly, if information is recorded in the execution of a task the information likewise remains intact even if unloaded. Likewise, this particular approach facilitates the sharing of multiple objects in a pool concurrently by more than one pipeline. For example, if information is entered in the performance of a task, that information, in this particular embodiment, would be available to all pipelines existing or later spawned that relate to that task, although, of course, claimed subject matter is not limited in scope in this respect.

In the preceding description, various aspects of claimed subject matter have been described. For purposes of explanation, systems and configurations were set forth to provide a thorough understanding of claimed subject matter. However, these are merely example illustrations of the above concepts wherein other illustrations may apply as well, and the scope of the claimed subject matter is not limited in these respects. It should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. An apparatus comprising: a computing platform;
said platform being adapted to manage a set of inter-related, self-service tasks, and being further adapted to produce a schedule;
said platform being further adapted to schedule at least some tasks so as to reduce the number of times the particular task is performed.

2. The apparatus of claim 1, wherein said tasks are specified at least in part by a system developer.

3. The apparatus of claim 2, wherein at least some of said tasks have been ordered by the system developer.

4. The apparatus of claim 1, wherein said schedule is produced for a user.

5. The apparatus of claim 1, wherein at least some of said tasks are interdependent.

6. The apparatus of claim 1, wherein at least some of the tasks have been ordered.

7. The apparatus of claim 1, wherein said computing platform is further adapted to prioritize at least some of said tasks.

8. The apparatus of claim 1, wherein said computing platform is further adapted to schedule only once at least one task in which information collected as a result of the task is used multiple times during execution.

9. The apparatus of claim 1, wherein said platform is further adapted to cascade a change in a particular task throughout said schedule.

10. The apparatus of claim 9, wherein said platform is adapted to undo previously scheduled tasks.

11. The apparatus of claim 10, wherein said platform is adapted to reschedule tasks the platform previously had operated to undo.

12. The apparatus of claim 1, wherein said platform is further adapted to produce a set of tasks, their inter-relationships, if any, and a schedule based at least in part upon information gathered by said platform.

13. The apparatus of claim 12, wherein said information is gathered in the form of responses provided by a user.

14. The apparatus of claim 13, wherein said platform is capable of adapting said set of tasks, their inter-relationships, if any, and said schedule at least in part based upon said user responses.

15. The apparatus of claim 13, wherein said responses are provided by a user as answers to a set of questions, wherein said set of questions is capable of adapting at least in part if an answer to a previous question is changed.

16. A method comprising:
producing a set of tasks, their inter-relationships and a schedule based at least in part on user responses to a set of questions;
modifying said tasks and schedule based at least in part on changes in said user responses; and
determining the amount of repetition in the schedule for one or more tasks.

17. The method of claim 16, further comprising: sharing information acquired through the performance of at least one task with another task.

18. The method of claim 18, wherein said set of questions is adaptive based at least in part on said user responses.

19. A method comprising:
managing a set of inter-related, self-service tasks, said managing including producing a schedule for a user; and
scheduling at least some tasks so as to reduce the number of times the particular task is performed.

20. The method of claim 19, wherein said scheduling comprises tracking identical tasks using a system provided reference number.

21. The method of claim 20, wherein said tracking comprises incrementing said reference number substantially in accordance with the number of times the task is invoked without reloading said task.

22. The method of claim 20, wherein said tracking comprises decrementing said reference number substantially in accordance with the number of times the task is unloaded.

23. A method comprising:
spawning one or more pipeline operations; and
executing tasks sequentially and/or concurrently in accordance with said spawned pipeline operations so as to reduce the number of times a redundant task is performed.

24. The method of claim 23, wherein said executing tasks comprises multithreading related tasks.

25. The method of claim 23, wherein said executing tasks comprises reducing duplication by executing a particular task only once.

26. The method of claim 25, wherein said executing a particular task only once comprises:
loading an object; and
assigning a reference number to the loaded object.

27. The method of claim 26, wherein said loading an object comprises: loading more than one object.

28. The method of claim 26, wherein said assigning a reference number comprises: incrementing said reference number associated with said object.

29. The method of claim 26, wherein said assigning a reference number comprises: decrementing said reference number if an object is unloaded.

30. The method of claim 23, and further comprising: reactivating a previously inactivated object in performance of a redo operation.

31. The method of claim 23, and further comprising: inactivating a previously reactivated object in performance of an undo operation.

32. An article comprising: a storage medium having stored thereon instructions, said instructions, if executed, resulting in:
managing a set of inter-related, self-service tasks, said managing including producing a schedule for an user; and
scheduling one or more tasks so as to reduce the number of times the particular task is performed.

33. The article of claim 32, wherein said instructions, if executed, further result in: scheduling comprising tracking identical tasks using a system provided reference number.

34. The article of claim 33, wherein said instructions, if executed, further result in: said tracking comprising incrementing said reference number substantially in accordance with the number of times the task is invoked without reloading said task.

35. The article of claim 33, wherein said instructions, if executed, further result in: said tracking comprising decrementing said reference number substantially in accordance with the number of times the task is unloaded.

36. An apparatus comprising:
means for managing a set of inter-related, self-service tasks, said means for managing including means for producing a schedule for a user; and
means for scheduling at least some tasks so as to reduce the number of times the particular task is performed.

37. The apparatus of claim 36, wherein said means for scheduling comprises means for tracking identical tasks using a system provided reference number.

38. The apparatus of claim 37, wherein said means for tracking comprises means for incrementing said reference number substantially in accordance with the number of times the task is invoked without reloading said task.

39. The apparatus of claim 37, wherein said means for tracking comprises means for decrementing said reference number substantially in accordance with the number of times the task is unloaded.
